(19) United States
(12) Patent Application Publication
(10) Pub. No.: US 2026/0039590 A1
(43) Pub. Date: Feb. 5, 2026

(54) INDICATION OF ADMISSIBLE COMMUNICATION TYPE

(71) Applicant: Nokia Technologies Oy, Espoo (FI)

(72) Inventors: Tero Juhani LÖTJÖNEN, Espoo (FI); Shubhranshu SINGH, Munich (DE); Laurent THIEBAUT, Massy (FR)

(21) Appl. No.: 19/099,445

(22) PCT Filed: Jul. 29, 2022
(86) PCT No.: PCT/EP2022/071355

§ 371 Date: Jan. 28, 2025

(51) Int. Cl. H04L 45/42; H04L 41/0893

(52) U.S. Cl. CPC H04L 45/42; H04L 41/0893

(57) ABSTRACT

Method comprising: monitoring whether a network function receives an indication of a group type of a group, wherein, for the group type, a set of one or more admissible types of traffic routing admitted for a communication within the group is stored; checking whether the set of one or more admissible types of traffic routing stored for the group type comprises a first type of traffic routing if the network function receives the indication; inhibiting the network function to instruct a user plane function to apply the first type of traffic routing to a communication between a first member of the group and a second member of the group if the set of the one or more admissible types of traffic routing does not comprise the first type of traffic routing.

### FIELD OF THE INVENTION

The present disclosure relates to group communication.

### ABBREVIATIONS

3GPP 3^{rd} Generation Partnership Project
5G/6G/7G 5^{th}/6^{th}/7^{th} Generation
5GC 5G Core network
5GS 5G System
AAA Authentication, Authorisation, Accounting
AF Application Function
API Application Programming Interface
DN Data Network
DNN Data Network Name
ECS Emergency Call Service
GPSI Generic Public Subscription Identifier
ID Identifier
lloT Industrial IoT
IoT Internet of Things
IP Internet Protocol
LAN Local Area Network
NEF Network Exposure Function
NF Network Function
PCC Policy and Charging Control
PCF Policy Control Function
PDU Protocol Data Unit
PSA PDU Session Anchor
QoS Quality of Service
SM Session Management
SMF Session Management Function
S-NSSAI Single Network Slice Selection Assistance Information
SSC Session and Service Continuity
SUPI Subscription Permanent Identifier
TR Technical Report
TS Technical Specification
UDM Unified Data Management
UDR Unified Data Repository
UE User Equipment
UPF User Plane Function
URSP UE Route Selection Policy
VN Virtual Network

### BACKGROUND

3GPP TR 23.700-74 [3]“Study on generic group management, exposure and communication enhancements (GMEC, Release 18)” defines the generic functions for the specified group of UEs. The clause 5.1 “Key Issue #1 (Enhance group attribute management)” describes the following: “Based on the scope of this study, a group can be set with service area or QoS that is applicable to each UE within the group.” This means that the network does not provide any service to members of the group if they are out of the service area, and that the network has to provide a certain QoS to each member of the group. A target of this study is to utilize the existing APIs as much as possible, but still ensure the support for the generic group of UEs.

There are two proposed solutions (Solution #8 and #9) in the TR, which reuse the 5G VN group principles to define the group of UEs. Because the 5G VN group management has been originally designed and specified for the 5G LAN -type of services, there is no separation between the group management and user plane (5G LAN communication) handling.

The current AF based 5G VN group management principles are described in 3GPP TS 23.502, clause 4.15.6, partially presented in 3GPP TR 23.700-74 solution #9). The information of 5G VN group related PDU session is carried either via the UDM via UDM sending Session Management related subscription information to SMF or via the PCC rules (3GPP TS 23.502 clause 4.16.12.2 UE Policy Association Modification initiated by the PCF).

5G VN Communication defines for a group an optimization of UE to UE communication between group members, which may include below three types of traffic forwarding:
N6 based traffic routing (between UPF and DN, where DN is outside 5GS)
N19-based traffic routing (between two PSA UPFs)
local path switch on the UPF (e.g. in case SMF select a single PSA UPF for PDU sessions targeting the same 5G VN group). This option may be seen as a special case of the N19-based traffic routing where the two PSA UPFs are the same.

According to the latest version (v0.3.0) of 3GPP TR 23.700-74 [3], “a group can be created using the 5G VN NEF API without using the 5G VN communication related features, since use of N19 and local path switching and other 5G VN specific features defined in 3GPP TS 23.501 [1], clause 5.8.2.13, are optional.” It is supposed that this reference to optional 5G VN communication relates to the statement of 3GPP TS 23.501 [1], clause 5.8.2.13, “The SMF may configure the UPF(s) to apply different traffic forwarding methods to route traffic between PDU Sessions for a single 5G VN group. For example, depending on the destination address, some packet flows may be forwarded locally, while other packet flows are forwarded via N19 and other packet flows are forwarded to N6.”

According to 3GPP TS 23.501 [1], clause 5.29.2 (5G VN group management), in order to support dynamic management of 5G VN Group: “The NEF exposes services to dynamically manage 5G VN group data.” and further: “The 5G VN group data may include the following parameters: PDU session type, DNN, S-NSSAI and Application descriptor, Information related with secondary authentication/authorization . . . ”,

According to 3GPP TS 23.501 [1], clause 5.29.3 (PDU Session management):
“Session management related policy control for a DNN and S-NSSAI as described in TS 23.502 [2], is applicable to the DNN and S-NSSAI associated to a 5G VN group. This includes also usage of URSP, for the UE to determine how to route outgoing traffic to a PDU Session for the DNN and S-NSSAI associated to a 5G VN group.”
“During the PDU Session Establishment procedure, the SMF retrieves SM subscription data related to 5G-VN type service from the UDM as part of the UE subscription data for the DNN and S-NSSAI.
In order to realize N19 traffic routing, the SMF correlates PDU sessions established to the same 5G VN group and uses this to configure the UPF with the group level N4-session including packet detection and forwarding rules for N19 tunnelling forwarding.”

According to 3GPP TS 29.244 [4], clause 8.2.25, the UPF's support of 5G VN Group Communication is optional (as a supported feature), but SMF is the one to control 5G VN Group Communication.

### REFERENCES

[1]3GPP TS 23.501: System architecture for the 5G System (5GS)
[2]3GPP TS 23.502: Procedures for the 5G System (5GS)
[3]3GPP TR 23.700-74: Study on generic group management, exposure and communication enhancements (GMEC)
[4]3GPP TS 29.244: Interface between the Control Plane and the User Plane Nodes (Stage 3)

### SUMMARY

It is an object of the present invention to improve the prior art.

According to a first aspect of the invention, there is provided an apparatus comprising:
one or more processors and memory storing instructions that, when executed by the one or more processors, cause the apparatus to perform:
monitoring whether a network function receives an indication of a group type of a group, wherein, for the group type, a set of one or more admissible types of traffic routing admitted for a communication within the group is stored;
checking whether the set of one or more admissible types of traffic routing stored for the group type comprises a first type of traffic routing if the network function receives the indication;
inhibiting the network function to instruct a user plane function to apply the first type of traffic routing to a communication between a first member of the group and a second member of the group if the set of the one or more admissible types of traffic routing does not comprise the first type of traffic routing.

According to a second aspect of the invention, there is provided an apparatus comprising:
one or more processors and memory storing instructions that, when executed by the one or more processors, cause the apparatus to perform:
monitoring whether an exposure function receives, from an application function, a request related to a group;
determining a group type of the group based on at least one of the following: the request and an identity of the application function;
informing a user data function on the group type of the group.

According to a third aspect of the invention, there is provided an apparatus comprising:
one or more processors and memory storing instructions that, when executed by the one or more processors, cause the apparatus to perform:
monitoring whether a user data function receives an indication that a group having a group type is created;
identifying a network function that has subscribed to a notification of the creation of the group if the user data function receives the indication;
notifying the network function on the creation of the group and the group type of the group.

According to a fourth aspect of the invention, there is provided an apparatus comprising:
one or more processors and memory storing instructions that, when executed by the one or more processors, cause the apparatus to perform:
monitoring whether a user data function receives an indication that a group type of a group is updated;
identifying a network function that has subscribed to a notification of the update of the group type of the group if the user data function receives the indication;
notifying the network function on the updated group type of the group.

According to a fifth aspect of the invention, there is provided a method comprising:
monitoring whether a network function receives an indication of a group type of a group, wherein, for the group type, a set of one or more admissible types of traffic routing admitted for a communication within the group is stored;
checking whether the set of one or more admissible types of traffic routing stored for the group type comprises a first type of traffic routing if the network function receives the indication;
inhibiting the network function to instruct a user plane function to apply the first type of traffic routing to a communication between a first member of the group and a second member of the group if the set of the one or more admissible types of traffic routing does not comprise the first type of traffic routing.

According to a sixth aspect of the invention, there is provided a method comprising:
monitoring whether an exposure function receives, from an application function, a request related to a group;
determining a group type of the group based on at least one of the following: the request and an identity of the application function;
informing a user data function on the group type of the group.

According to a seventh aspect of the invention, there is provided a method comprising:
monitoring whether a user data function receives an indication that a group having a group type is created;
identifying a network function that has subscribed to a notification of the creation of the group if the user data function receives the indication;
notifying the network function on the creation of the group and the group type of the group.

According to an eighth aspect of the invention, there is provided a method comprising:
monitoring whether a user data function receives an indication that a group type of a group is updated;
identifying a network function that has subscribed to a notification of the update of the group type of the group if the user data function receives the indication;
notifying the network function on the updated group type of the group.

Each of the methods of the fifth to eighth aspects may be a method of group communication.

According to a ninth aspect of the invention, there is provided a computer program product comprising a set of instructions which, when executed on an apparatus, is configured to cause the apparatus to carry out the method according to any of the fifth to eighth aspects. The computer program product may be embodied as a computer-readable medium or directly loadable into a computer.

According to some embodiments of the invention, at least one of the following advantages may be achieved:
An appropriate admissible traffic routing type may be set for each group;
This allows avoiding the pain of establishing intra group data plane optimizations for groups that don't need such optimization e.g. because the group members only seldom exchange direct traffic with each other
UE is not impacted.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows a message flow according to some example embodiments of the invention;

FIG. 2 shows an apparatus according to an example embodiment of the invention;

FIG. 3 shows a method according to an example embodiment of the invention;

FIG. 4 shows an apparatus according to an example embodiment of the invention;

FIG. 5 shows a method according to an example embodiment of the invention;

FIG. 6 shows an apparatus according to an example embodiment of the invention;

FIG. 7 shows a method according to an example embodiment of the invention;

FIG. 8 shows an apparatus according to an example embodiment of the invention;

FIG. 9 shows a method according to an example embodiment of the invention; and

FIG. 10 shows an apparatus according to an example embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Currently there is no way to allow NFs, e.g. SMF or PCF, to determine whether or not a data path dedicated to 5G VN group communication is to be established for the members of an established 5G VN group. Besides, there are several use cases, e.g. as mentioned in the white paper “Exposure of 5G capabilities for connected industries and automation applications” published by 5G ACIA on www.5g-acia.org/publications, that requires lloT devices to be grouped together in a “generic group”, while the group creation and provisioning may use same procedure as 5G VN group. In a “generic group”, 5G VN group communication is not admitted. In such cases, there is currently no indication available to create a generic group of UEs, without the 5G VN group communication, in the 5G VN group data parameters from AF nor the related event exposure/PCC rules. Accordingly, such an indication cannot be provided to a target 5GC NF, e.g. SMF or PCF. According to 3GPP TS 23.501, clause 5.29.3, the URSP data is not expected to contain group level information

According to some example embodiments of the invention, AF provides an additional parameter to 5GC indicating a group type. The group type implies a set of admissible types of traffic routing for communication within the group. The set may comprise one or more admissible types. The “group type” may have the values “generic group” or “5G VN group”, for example, where the admissible traffic routing types are defined for each “group type”. E.g., one or both of N19-based traffic routing and local path switch may be admissible only for the “5G VN group” but not for the “generic group”.

In the NFs (in particular: SMF), for each group type, the types of traffic routing comprised by the set of admissible types of traffic routing may be stored. The admissible types of traffic routing may be defined explicitly or implicitly. For example, they may be defined explicitly by a list of admissible traffic types for each group type. As another option, they may implicitly by a list of forbidden traffic routing types for each group type. Traffic routing types not comprised in the list are admitted for this group type. If a group type is not indicated explicitly for a group, the NF may assume that the group belongs to a default group type. For the default group type, admissible types of traffic routing may be defined explicitly or implicitly, too. 5GC will have handle a communication within a group according to the indicated admissible traffic routing types for the group type of the group. For example, SMF may, based on the group type of a group, determine whether or not it may apply 5G VN group communication mechanisms for a communication within the group (possibly involving establishment of N19 links between PSA UPF serving members of the 5G VN group).

When the set of admissible traffic routing types does not indicate “5G VN Communication” (i.e. one or both of N19-based traffic routing and local path switch), this means that this type of optimization of UE to UE communication between group members is not admitted. In this case, N6-based traffic routing may support UE-UE group communication (i.e. communication between UEs within the group).

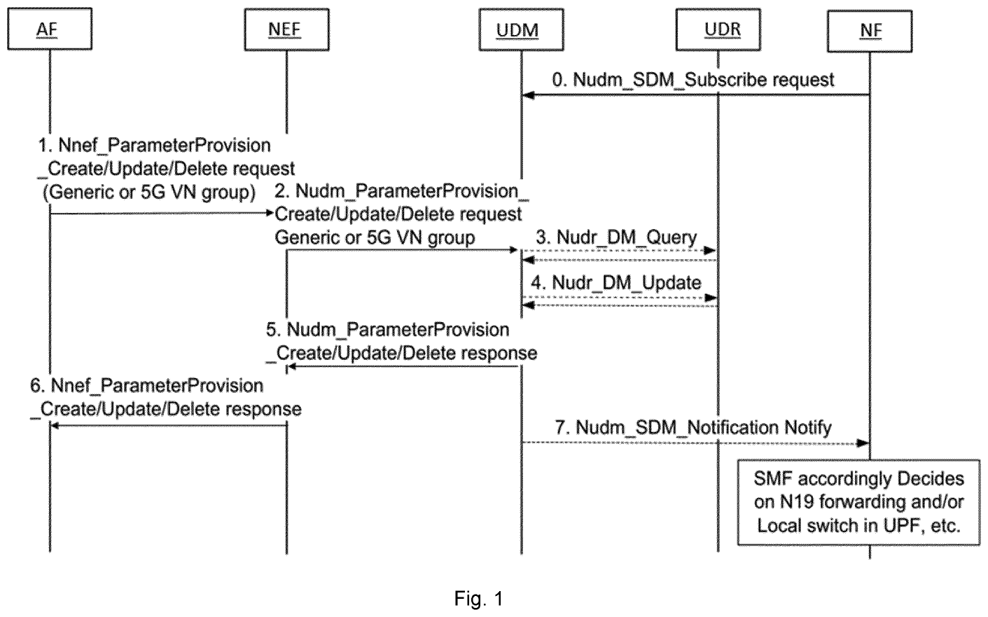

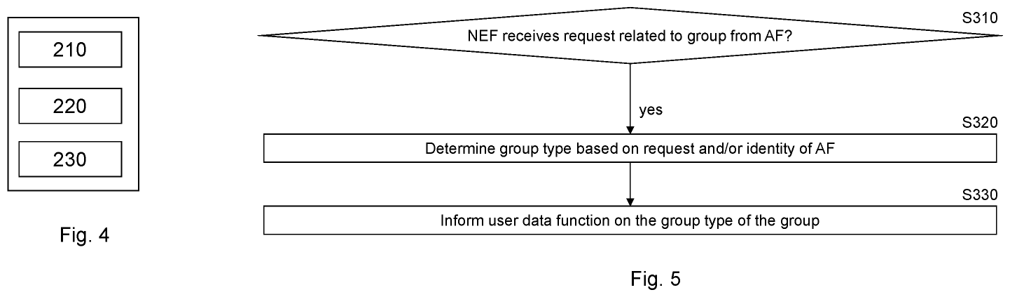

FIG. 1 shows a message flow according to some example embodiments of the invention. In FIG. 1, an indication of the group type is taken as an example of an indication of the set of admissible types of traffic routing. NF in FIG. 1 may be any of SMF, AMF, and PCF. The explanation below assumes that NF is a SMF. FIG. 1 and its explanation are based on 3GPP TS 23.502, FIG. 4.15.6.2-1, which are adapted according to some example embodiments of the invention.

The actions shown in FIG. 1 are as follows:

0. SMF subscribes to UDM notifications Group Subscription data updates. In addition, it may subscribe to UE subscription data updates for UEs of the group.

NOTE 1: The SMF can subscribe to Group Subscription data from UDM in this step and be notified of Group Subscription data updates in step 7 using the Shared Data feature defined in 3GPP TS 29.503.

1. The AF provides one or more parameter(s) to be created or updated in a Nnef_ParameterProvision_Create or Nnef_ParameterProvision_Update to the NEF.

For a Create request associated with a 5G VN group, the External Group ID identifies the 5G VN Group.
5G VN group membership management parameters (as in 3GPP TS 23.502, clause 4.15.6.3c);
External Group Id and 5G VN group data (i.e. 5G-VN configuration parameters) (as in 3GPP TS 23.502, clause 4.15.6.3b, with the modification described below),

TABLE 1
(taken from 3GPP TS 23.502, Table 4.15.6.3b-
1): Description of 5G VN group data with extra
information defined as part of the invention

| Parameters | Description |
|---|---|
| DNN | DNN for the 5G (VN) group |
| S-NSSAI | S-NSSAI for the 5G (VN) group |
| Group type | Indicates the type of group e.g. whether |
| | the group is associated with 5G VN |
| | communication mechanisms defined in 3GPP |
| | TS 23.501, clauses 5.29.3 and 5.29.4 |
| PDU Session Type | PDU Session Types allowed for 5G VN group |
| Application | There may be multiple instances of this |
| descriptor | information; this information may be used |
| | to build URSP sent to 5G VN group members |
| | (NOTE 1) |
| Information related | This may indicate: |
| with secondary | the need for secondary authentication/ |
| authentication/ | authorization (as defined in |
| authorization | clause 5.6 of TS 23.501 [2]); |
| | the need for SMF to request the UE IP |
| | address from the DN-AAA Server. |
| | If at least one of secondary |
| | authentication/authorization or DN-AAA |
| | UE IP address allocation is needed, the |
| | AF may provide DN-AAA Server addressing |
| | information. |

(NOTE 1):
As described in TS 23.503 [20], the PCF may be configured with a mapping from Application Descriptor to other information required to construct the URSP rules, e.g. IP filters and SSC mode.

The term “5G (VN) group” indicates a 5G group which may or may not be a 5G VN group.

The AF may also request to delete 5G VN configuration by sending Nnef_ParameterProvision_Delete to the NEF.

2. If the AF is authorised by the NEF to provision the parameters, the NEF requests to create, update and store, or delete the provisioned parameters as part of the subscriber data via Nudm_ParameterProvision_Create, Nudm_ParameterProvision_Update or Nudm_ParameterProvision_Delete Request message, the message includes the provisioned data and NEF reference ID and optionally MTC Provider Information. The NEF may determine that the group is of a generic group type (not requiring 5G VN data path optimizations) based on local policies related e.g. with the identity of the AF having issued the group related request or related with the parameters indicated in the group related request (for example the local policies may take into account the MTC Provider Information or the S-NSSAI provided in the request for such determination).

3. UDM may read from UDR, by means of Nudr_DM_Query, corresponding subscription information in order to validate required data updates and authorize these changes for this subscriber or Group for the corresponding AF. Herein, any of UDM, UDR, or their combination may be denoted as a “user data function”.

4. If the AF is authorised by the UDM to provision the parameters for this subscriber, the UDM resolves the GPSI to SUPI, and requests to create, update or delete the provisioned parameters as part of the subscriber data via Nudr_DM_Create/Update/Delete Request message, the message includes the provisioned data.

If a new 5G VN group is created, the UDM shall assign a unique Internal Group ID for the 5G VN group and include the newly assigned Internal Group ID in the Nudr_DM_Create Reque message. If the list of 5G VN group members is changed or if 5G VN group data has changed, the UDM updates the UE and/or Group subscription data according to the AF/NEF request.

UDR stores the provisioned data as part of the UE and/or Group subscription data and responds with Nudr_DM_Create/Update/Delete Response message.

When the 5G VN group data is updated, the UDR notifies to the subscribed PCF by sending Nudr_DM_Notify as defined in 3GPP TS 23.502, clause 4.16.12.2.

If the AF is not authorised to provision the parameters, then the UDM continues in action 5 indicating the reason to failure in Nudm_ParameterProvision_Update Response message and action 7 is not executed.

The UDM classifies the received parameters (i.e. Expected UE Behaviour parameters or Suggested Number of Downlink Packets or the 5G VN configuration parameters or Location Privacy Indication parameters or ECS Address Configuration Information), into AMF associated and SMF associated parameters. The UDM may use the AF Identifier received from the NEF in action 2 to relate the received parameter with a particular subscribed DNN and/or S-NSSAI. The UDM stores the SMF-Associated parameters under corresponding Session Management Subscription data type.

5. UDM responds the request with Nudm_ParameterProvision_Create/Update/Delete Response. If the procedure failed, the cause value indicates the reason.

6. NEF responds the request with Nnef_ParameterProvision_Create/Update/Delete Response. If the procedure failed, the cause value indicates the reason of the failure.

7. [Conditional this action is performed only after successfully performing action 4] UDM notifies the subscribed Network Function NF (e.g., AMF or SMF) of the updated UE and/or Group subscription data via Nudm_SDM_Notification Notify message or the UDM provides the Group subscription data updates with the Shared data mechanism defined by 3GPP TS 29.503. This action may also correspond to SMF fetching subscription data as part the establishment of a PDU Session as described in action 4 of 3GPP TS 23.502, clause 4.3.2.2.1, and in action 7 of 3GPP TS 23.502, clause 4.3.2.2.2 (SMF retrieves the Session Management Subscription data using Nudm_SDM_Get)

If a UE is member of a 5G (VN) Group, UDM retrieves UE subscription data and corresponding 5G (VN) group data from UDR, and provides the AMF and SMF with UE subscription data with 5G (VN) group data included.
a) If the NF is AMF, the UDM performs Nudm_SDM_Notification (SUPI and Internal Group Identifier, Group type etc.) service operation. It includes Group Type indicating the type of group e.g. whether or not the group is associated with 5G VN communication mechanisms . . .
b) If the NF is SMF, the UDM performs Nudm_SDM_Notification (SUPI and Internal Group Identifier, Group type etc.) service operation. It includes Group Type indicating the type of group e.g. whether or not the group is associated with 5G VN communication mechanisms.

If the UE does not belong to a 5G (VN) group OR if the UE belongs to a group and configured as ‘generic” group i.e. with indication set of admissible types of traffic routing, SMF uses Group type information to determine NOT to invoke 5G VN communication mechanisms (i.e. LAN-type communication). I.e., the SMF does not correlate PDU sessions established to the same 5G VN group and does not use this to configure the UPF with the group level N4-session including packet detection and forwarding rules for N19 traffic routing (also denoted N19 tunnelling forwarding). Thus in this case, SMF ensures that there is no local path switch or N19 traffic routing on the PSA UPF.

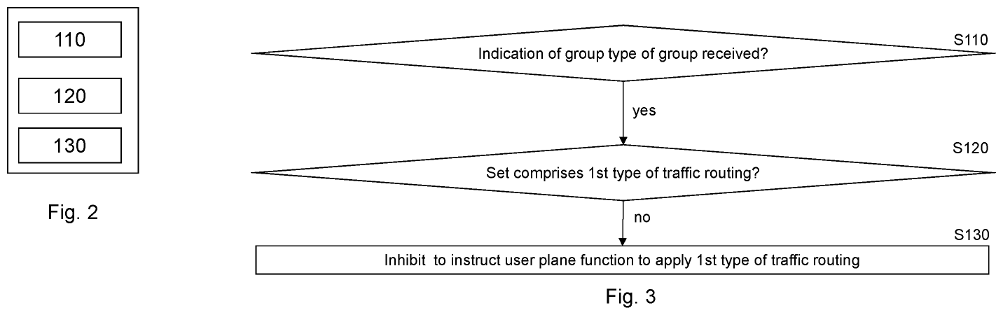

FIG. 2 shows an apparatus according to an example embodiment of the invention. The apparatus may be a network function (such as a SMF, AMF, or PCF) or an element thereof. FIG. 3 shows a method according to an example embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises means for monitoring 110, means for checking 120, and means for inhibiting 130. The means for monitoring 110, means for checking 120, and means for inhibiting 130 may be a monitoring means, checking means, and inhibiting means, respectively. The means for monitoring 110, means for checking 120, and means for inhibiting 130 may be a monitor, checker, and inhibiter, respectively. The means for monitoring 110, means for checking 120, and means for inhibiting 130 may be a monitoring processor, checking processor, and inhibiting processor, respectively.

The means for monitoring 110 monitors whether a network function (e.g. SMF, AMF, or PCF) receives an indication of a group type of a group (S110). For each group type, a set of one or more admissible types of traffic routing is stored. If the network function receives the indication (S110=yes), the means for checking 120 checks whether the set of the one or more admissible types of traffic routing for the group type comprises a first type of traffic routing (S120).

If the set of the one or more admissible types does not comprise the first type of traffic routing (S120=no), the means for inhibiting 130 inhibits the network function to instruct a user plane function to apply the first type of traffic routing to a communication between a first member of the group and a second member of the group (S130).

FIG. 4 shows an apparatus according to an example embodiment of the invention. The apparatus may be an exposure function (such as a NEF) or an element thereof. FIG. 5 shows a method according to an example embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises means for monitoring 210, means for determining 220, and means for informing 230. The means for monitoring 210, means for determining 220, and means for informing 230 may be a monitoring means, determining means, and informing means, respectively. The means for monitoring 210, means for determining 220, and means for informing 230 may be a monitor, determiner, and informer, respectively. The means for monitoring 210, means for determining 220, and means for informing 230 may be a monitoring processor, determining processor, and informing processor, respectively.

The means for monitoring 210 monitors, whether an exposure function (such as a NEF) receives a request related to a group from an application function (S210). If the exposure function receives the request related to the group (S210=yes), the means for determining 220 determines a group type of the group (S220). The determining may be based on one or both of the request and an identity of the application function. The means for informing 230 informs a user data function (e.g. UDM or UDR or their combination) on the group type of the group (S230).

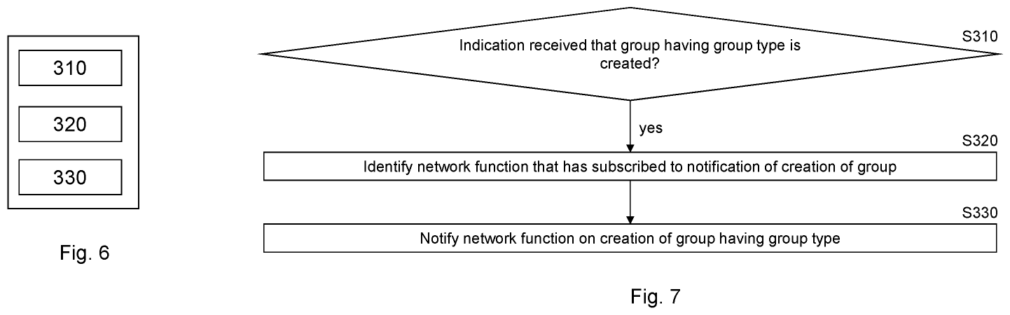

FIG. 6 shows an apparatus according to an example embodiment of the invention. The apparatus may be a user data function (such as a UDM or a UDR or a combination of UDM and UDR) or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for monitoring 310, means for identifying 320, and means for notifying 330. The means for monitoring 310, means for identifying 320, and means for notifying 330 may be a monitoring means, identifying means, and notifying means, respectively. The means for monitoring 310, means for identifying 320, and means for notifying 330 may be a monitor, identificator, and notifier, respectively. The means for monitoring 310, means for identifying 320, and means for notifying 330 may be a monitoring processor, identifying processor, and notifying processor, respectively.

The means for monitoring 310 monitors whether a user data function receives an indication that a group having a group type is created (S310). If the user data function receives the indication (S310=yes), the means for identifying 320 identifies a network function that has subscribed to a notification of the creation of the group (S320). The means for notifying 330 notifies the identified network function on the creation of the group and the group type of the group (S330).

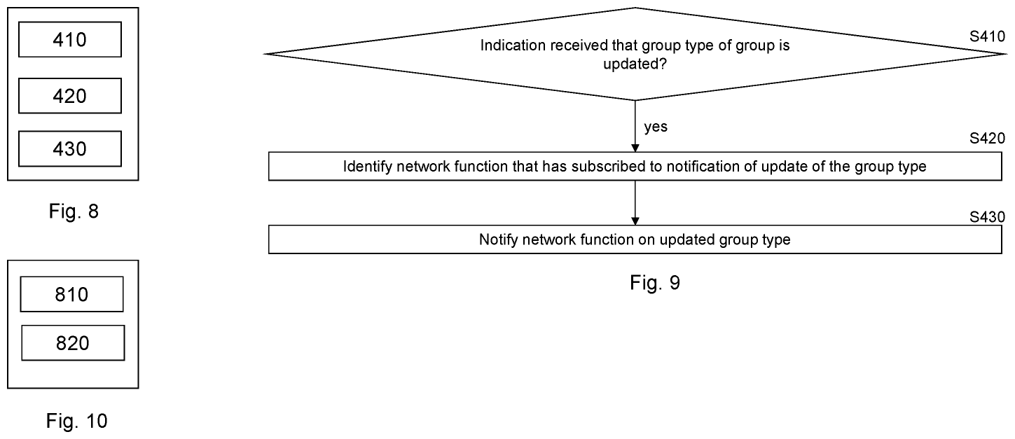

FIG. 8 shows an apparatus according to an example embodiment of the invention. The apparatus may be a user data function (such as a UDM or a UDR or a combination of UDM and UDR) or an element thereof. FIG. 9 shows a method according to an example embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises means for monitoring 410, means for identifying 420, and means for notifying 430. The means for monitoring 410, means for identifying 420, and means for notifying 430 may be a monitoring means, identifying means, and notifying means, respectively. The means for monitoring 410, means for identifying 420, and means for notifying 430 may be a monitor, identificator, and notifier, respectively. The means for monitoring 410, means for identifying 420, and means for notifying 430 may be a monitoring processor, identifying processor, and notifying processor, respectively.

The means for monitoring 410 monitors whether a user data function receives an indication that a group type of a group is updated (S410). If the user data function receives the indication (S410=yes), the means for identifying 420 identifies a network function that has subscribed to a notification of the update of the group type of the group (S420). The means for notifying 430 notifies the identified network function on the updated group type of the group (S430).

FIG. 10 shows an apparatus according to an example embodiment of the invention. The apparatus comprises at least one processor 810, at least one memory 820 storing instructions that, when executed by the at least one processor 810, cause the apparatus at least to perform the method according to at least one of the following figures and related description: FIG. 3 or FIG. 5 or FIG. 7 or FIG. 9.

Some example embodiments are explained with respect to a LAN type of traffic routing (5G VN communication). However, the invention is not limited to the LAN type of traffic routing. It may be applied to any specific kind of traffic routing.

Instead of subscribing to notifications, the NF (e.g. SMF, AMF, or PCF) may regularly poll the user data function whether a new group with some admissible types of traffic routing is created or if the set of admissible types of traffic routing of an existing group was changed. As another option, the user data service may broadcast an indication when a new group with some admissible types of traffic routing is created or if the set of admissible types of traffic routing of an existing group was changed. As a still further option, NEF may inform not only the user data function on the set of admissible traffic types abut also the NF (SMF, AMF, or PCF).

In some example embodiments, instead of the AF outside the 5GS (as according to FIG. 1), a network function of the 5GS may update, in the UDM/UDR, the set of admissible traffic routing types for a group. This update is not via NEF (as according to FIG. 1) but directly from the respective network function to UDM/UDR.

Some example embodiments are explained with respect to a 5G network. However, the invention is not limited to 5G networks. It may be used in other 3GPP networks such as 4G, 6G, and 7G, or even in non-3GPP networks if corresponding functions are provided.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, a network function (such as an SMF or an AMF or a PCF) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, an exposure function (such as a NEF) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a user data function (such as a UDM, or a UDR, or a combination of UDM and UDR) or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

The terms “first X” and “second X” include the options that “first X” is the same as “second X” and that “first X” is different from “second X”, unless otherwise specified. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

1. An apparatus comprising:
one or more processors; and
at least one memory storing instructions of a network function that, when executed by the one or more processors, cause the apparatus to perform operations, the operations comprising:
receiving, by the network function, an indication of a group type of a group comprising members, wherein the members comprise user equipments, wherein, for the group type, information indicating a set of admissible types of traffic routing admitted for a communication within the group is stored;
checking, by the network function, based on the indication, whether the set of admissible types of traffic routing for the group type comprises a first type of traffic routing; and
inhibiting the network function from instructing a user plane function to apply the first type of traffic routing to a communication between a first member of the group and a second member of the group if the set of the one or more admissible types of traffic routing does not comprise the first type of traffic routing.

2. The apparatus according to claim 1, wherein the operations further comprise:
instructing the user plane function to apply the first type of traffic routing for the communication between the first member of the group and the second member of the group if the set of the one or more admissible types comprises the first type of traffic routing.

3. The apparatus according to claim 1, wherein the first type of traffic routing comprises a local area network type traffic routing between the first member and the second member, wherein the local area network type of traffic routing allows, on a user plane for the communication, forwarding of traffic between the first member and the second member between a first user plane function serving the first member and a second user plane function serving the second member without crossing a data network.

4. The apparatus according to claim 1, wherein the operations further comprise:
subscribing to a notification of a creation of the group; and
wherein the receiving comprises receiving the notification.

5.-12. (canceled)

13. A method of an apparatus comprising a network function, the method comprising:
receiving, by the network function, an indication of a group type of a group comprising members, wherein the members comprise user equipments, wherein, for the group type, information indicating a set of admissible types of traffic routing admitted for a communication within the group is stored;
checking, by the network function, based on the indication, whether the set of admissible types of traffic routing for the group type comprises a first type of traffic routing; and
inhibiting the network function from instructing a user plane function to apply the first type of traffic routing to a communication between a first member of the group and a second member of the group if the set of the one or more admissible types of traffic routing does not comprise the first type of traffic routing; or
instructing the user plane function to apply the first type of traffic routing for the communication between the first member of the group and the second member of the group if the set of the one or more admissible types comprises the first type of traffic routing.

14. (canceled)

15. The method according to claim 13, wherein the first type of traffic routing comprises a local area network type traffic routing between the first member and the second member, wherein the local area network type of traffic routing allows, on a user plane for the communication, forwarding of traffic between the first member and the second member between a first user plane function serving the first member and a second user plane function serving the second member without crossing a data network.

16. The method according to claim 13, further comprising
subscribing to a notification of a creation of the group; and
wherein the receiving comprises receiving the notification.

17.-26. (canceled)

27. The apparatus according to claim 4, wherein the notification comprises the indication.

28. The apparatus according to claim 1, wherein the operations further comprise:
subscribing to a notification of an update related to the group; and
wherein the receiving comprises receiving the notification.

29. The apparatus according to claim 28, wherein the notification comprises the indication.

30. The apparatus according to claim 1, wherein the network function comprises a session management function, an access management function, or a policy control function.

31. The method according to claim 16, wherein the notification comprises the indication.

32. The method according to claim 13, further comprising:
subscribing to a notification of an update related to the group; and
wherein the receiving comprises receiving the notification.

33. The method according to claim 32, wherein the notification comprises the indication.

34. The method according to claim 13, wherein the network function comprises a session management function, an access management function, or a policy control function.

35. A non-transitory computer-readable medium storing instructions which, when executed by at least one processor of a device cause the device to perform operations, the operations comprising:
receiving, by the network function, an indication of a group type of a group comprising members, wherein the members comprise user equipments, wherein, for the group type, information indicating a set of admissible types of traffic routing admitted for a communication within the group is stored;
checking, by the network function, based on the indication, whether the set of admissible types of traffic routing for the group type comprises a first type of traffic routing;
inhibiting the network function from instructing a user plane function to apply the first type of traffic routing to a communication between a first member of the group and a second member of the group if the set of the one or more admissible types of traffic routing does not comprise the first type of traffic routing.

36. The non-transitory computer-readable medium according to claim 35, wherein the operations further comprise:
instructing the user plane function to apply the first type of traffic routing for the communication between the first member of the group and the second member of the group if the set of the one or more admissible types comprises the first type of traffic routing.

37. The non-transitory computer-readable medium according to claim 35, wherein the first type of traffic routing comprises a local area network type traffic routing between the first member and the second member, wherein the local area network type of traffic routing allows, on a user plane for the communication, forwarding of traffic between the first member and the second member between a first user plane function serving the first member and a second user plane function serving the second member without crossing a data network.

38. The non-transitory computer-readable medium according to claim 35, wherein the operations further comprise:
subscribing to a notification of a creation of the group; and
wherein the receiving comprises receiving the notification.

39. The non-transitory computer-readable medium according to claim 38, wherein the notification comprises the indication.
